(19) United States
(12) Patent Application Publication
(10) Pub. No.: US 2004/0134275 A1
(43) Pub. Date: Jul. 15, 2004

(54) Method for measuring and/or machining a workpiece

(76) Inventors: Dieter Reichel, Neumarkt (DE); Jurgen Feix, Germering (DE); Erich Lindner, Auerbach-Nasnitz (DE); Ralf Waidhauser, Neumarkt (DE)

Correspondence Address: Stephen E Bondura, Dority & Manning, P O Box 1449, Greenville, SC, 29602-1449, US

(21) Appl. No.: 10/468,513

(22) PCT Filed: Feb. 19, 2002
(86) PCT No.: PCT/EP02/01734

(30) Foreign Application Priority Data
Feb. 20, 2001 (DE) 101 08 139.1

(51) Int. Cl. G06F 19/00

(52) U.S. Cl. 73/432.1; 700/194

(57) ABSTRACT

A method for measuring and/or machining a workpiece (1, 2), especially modules in building construction by means of a measuring and/or machining device (30) is presented, in which the workpiece (1, 2) is determined in a first coordinate system (21) with the aid of at least one determining [detection] device (10) and that the measuring and/or machining device (30), that can move relative to the workpiece (1, 2), is determined in a second coordinate system (22) independently of the position and the shape of the workpiece (1, 2). The coordinates of the workpiece (1, 2) on the one hand, and the coordinates of the measuring and/or machining device (30) on the other hand, are brought into a relationship with each other by a computer (40) in order to control the measuring and/or machining device (30) for measuring and machining the workpiece (1, 2).

The invention is relative to a method for measuring and/or machining a workpiece, especially modules in building construction by means of a measuring and/or machining device.

In known methods of this type workpieces with relatively small dimensions are clamped, e.g., into a milling machine and subsequently machined with the milling tool. In the case of larger workpieces the measuring and/or machining device, e.g., a tool on a robot arm, is presented to the workpiece, during which transmitter/receiver devices on the robot direct signals onto the workpiece and receive the returning signals. Based on the signals, the shape and the position of the workpiece and the relative position of the tool are then determined based on the signals. A computer then calculates from this information which movements the tool must execute for being presented to and for machining the workpiece.

This method has the disadvantage, particularly in the case of rather large workpieces, that the determination is relatively complex and not very flexible, and, in addition, a very precise adjusting of one or more sender/receiver units is necessary.

The present invention has the problem of further developing a method of the initially cited type in such a manner that a measuring and/or machining of workpieces, especially ones of a considerable size such as, e.g., large construction modules, can be carried out in a simple and rapid manner.

This problem is solved in a method of the initially cited type in that the workpiece is determined in a first coordinate system with the aid of at least one determining [detection] device and that the measuring and/or machining device, that can move relative to the workpiece, is determined in a second coordinate system independently of the position and the shape of the workpiece, and that the coordinates of the workpiece on the one hand and the coordinates of the measuring and/or machining device on the other hand are brought into a relationship with each other by a computer in order to control the measuring and/or machining device for measuring and machining the workpiece.

A distinction is to be made here between the concepts determination on the one hand and gauging or measuring on the other hand. The so-called determination concerns in the sense of this invention the determining of position and shape of the workpiece as well as at least the location or the position of the measuring and/or machining device. Its shape can optionally be already stored in the computer or is likewise determined. The determining device preferably comprises a transmitting module—e.g., even the ambient light can possibly suffice—and a receiving module is obligatory.

In contrast thereto, a gauging or measuring in the sense of this invention represents an action of a measuring device on the workpiece just as the machining is an action of a machining device. The measuring can be performed with or without contact on the workpiece. For example, various physical and/or chemical magnitudes can be measured, including the precise shape of the workpiece, surface properties, color, material composition, moisture content, electrical magnitudes, etc.

The basic concept of the invention resides in separately determining and storing the workpiece in its own coordinate system on the one hand and the measuring and/or machining device in its own coordinate system on the other hand.

If the workpiece is stationary, as in an especially preferred variant of the invention, the coordinate system of the workpiece after it has been determined is purposefully assumed to be fixed. This procedure is in particular advantageous when the workpiece has large spatial dimensions and/or a high weight, e.g., a large construction module, and could therefore be adjusted only with great complexity in a given external coordinate system.

The advantages of the invention are in particular that no direct and complicated communication between the measuring device or tool, that is, measuring and/or machining device on the one hand and between the workpiece on the other hand is necessary. The workpiece as well as the measuring and/or machining device can be determined relatively rapidly with the method of the invention in order to then perform the positioning of the measuring and/or machining device with a computer. Moreover, the invention has the advantage that the determining device can be arranged largely independently of the design of the workpiece and of the measuring and/or machining device. A largely freely selectable arrangement in space is possible with a mobile design of the determining device. Moreover, no exact guidance or positioning of the measuring and/or machining device is necessary prior to the measuring or machining on account of the functional separation of the two coordinate systems.

It is advantageous if the first and the second coordinate systems are brought into the specified relationship in a third coordinate system. This third coordinate system is advantageously a global, that is, stationary coordinate system. In this instance the first as well as the second coordinate system are transformed into the third coordinate system and the measuring and/or machining of the workpiece is/are controlled starting from this latter coordinate system.

The third, advantageously global coordinate system is advantageously fixed by the determining device itself and direct signals from the transmitting module are advantageously received by sensors that are fixed in space. The transmitting module and sensors form part of the determining device. Based on the detection of the signals transmitted directly to the sensors and received by them on the one hand and of the indirect signals on the other hand that reach the sensors from the workpiece (or the measuring and/or machining device), conclusions can be made with the aid of the computer about the relationship between the first (or the second) coordinate system in the third coordinate system and the specified transformations into the third coordinate system can be made.

The fixing of the third coordinate system is purposefully equal to a calibration of the determining system. It is also possible by virtue of this calibration to place the first and the second coordinate system in a relationship without explicitly including the third coordinate system. In this instance the second coordinate system is transformed into the first one or vice versa with the aid of calibration data.

In an advantageous further development of the method the workpiece is determined in the first coordinate system only before the measuring or machining. If the workpiece remains stationary during the measuring and/or machining this one determination can suffice. Of course, a success check can be made at the end of the measuring and/or machining.

The workpiece is preferably determined in at least two partial determination steps, especially in a one-time determination. A relatively large section of the workpiece or the entire workpiece is determined with a certain resolution in the one partial determination step. In another partial determination step the determining device is brought closer to the workpiece and a section of the previously determined section is recorded with a finer resolution. The data determined in the two partial determination steps is subsequently adjusted via a computer in order to obtain a three-dimensional image of the workpiece that is as complete as possible. After the determination the workpiece data can then be used for the machining by the machining device or for a detailed measuring of the workpiece.

A deviation of the actual state of the workpiece from its theoretical state is preferably calculated by the determination of the position and the shape of the workpiece in order to calculate the necessary machining steps from the differential data with computer support.

The measuring and/or machining device needs to be detected only once in its second coordinate system for an approximate approach to the workpiece. On the other hand, it is advantageous for a more precise measuring or for the machining of the workpiece if a repeated determination of the measuring and/or machining device is carried out. This can preferably be realized in several steps that are successive in time or in a continuous manner. In this manner a very precise and constantly controlled measuring or machining of the workpiece is possible based on the current determination data.

The determination of the workplace and of the measuring and/or machining device can be carried out in principle with many different methods, e.g., with ultrasound, theodolites, as well as various image-producing methods. Laser beams transmitted by at least one transmitting module of the determining device are preferably used. An especially suitable device, e.g., such a device is known under the commercial name of “laser tracker”, is based on the principle of laser interferometry, in which at least one laser is placed at a suitable interval in front of the workpiece. Its location in space and therewith relative to the workpiece and to the measuring and/or machining device is advantageously determined by at least one, preferably by several sensors distributed in space that represent a receiving module of the determining device.

Reflection elements placed in the immediate vicinity of the surface to be determined are preferably used that reflect laser beams emanating from the at least one laser. The reflection elements preferably have a spherical surface that faces the laser and on which the beams emanating from the laser are reflected in space to the sensors. Since the surface in question must be precisely determined, these reflection elements are advantageously designed to be small (in the mm or cm range) in comparison to the surface to be detected. The reflection elements are inserted, e.g., into bores manufactured with a defined depth. Furthermore, laser devices are known that are controlled in such a manner that they themselves seek these reflection elements. Alternatively, a manual guidance of the at least one laser is possible.

In an advantageous embodiment of the invention the determining device is arranged to be stationary at each determination of the measuring and/or machining device. The determining device remains in this instance either at its old location or is set up at another, more favorable location before the next determination. This procedure has the advantage that the determination can be carried out in a very simple manner and especially with relatively great flexibility as regards the setting up of the determining device. In addition it can be sufficient to use only a single determining device in order to determine in succession the workpiece and the measuring and/or machining device, possibly in a repetitive manner.

In an alternative variant of the invention the determining device is moved during the determining of the measuring and/or machining device in a defined manner with the latter in the second coordinate system. To this end the determining device is preferably fastened to the measuring and/or machining device and follows its movements. This can necessitate a more complex construction but the precision of the determination can possibly be increased. However, several determination devices may be necessary, depending on the complexity of the design of the measuring and/or machining device.

It is especially preferable if the measuring and/or machining device comprises at least one but preferably several measuring and/or machining devices that can preferably be controlled individually. Such a design is applicable, e.g., if several machining locations of the workpiece that have the same shape are to be machined at a defined distance from each other in the same manner.

A preferred method course consists in that the measuring and/or machining device is brought up close to the workpiece and subsequently the individual measuring and/or machining devices are moved into their operating positions in order to measure and/or machine the workpiece. This procedure in two steps is rapid and simple and the first step of the approach of the measuring and/or machining device to the workpiece does not require any exact guidance and/or positioning of the measuring and/or machining device. In the second step of the fine measuring and/or machining, repeated determining steps are then purposeful.

For a measuring and/or machining of the workpiece the measuring and/or machining device can either be placed on the workpiece in such a manner that it contacts it or it can be placed adjacent to the workpiece without making contact with it, e.g., arranged on a gantry crane.

The invention can be used, e.g., in the machining of connecting brackets worked into roadway carriers for rail vehicles and in particular for magnetic suspended railway vehicles. After being machined, operational plane carriers are fastened on the connecting consoles which carriers comprise, e.g., stators for the vehicle drive. The workpiece in the sense of this invention is the roadway carrier consisting of pre-stressed concrete together with the connecting consoles attached to it.

Advantageous further developments of the invention are characterized by the features of the subclaims.

The invention is explained in detail in the following with reference made to the drawings.

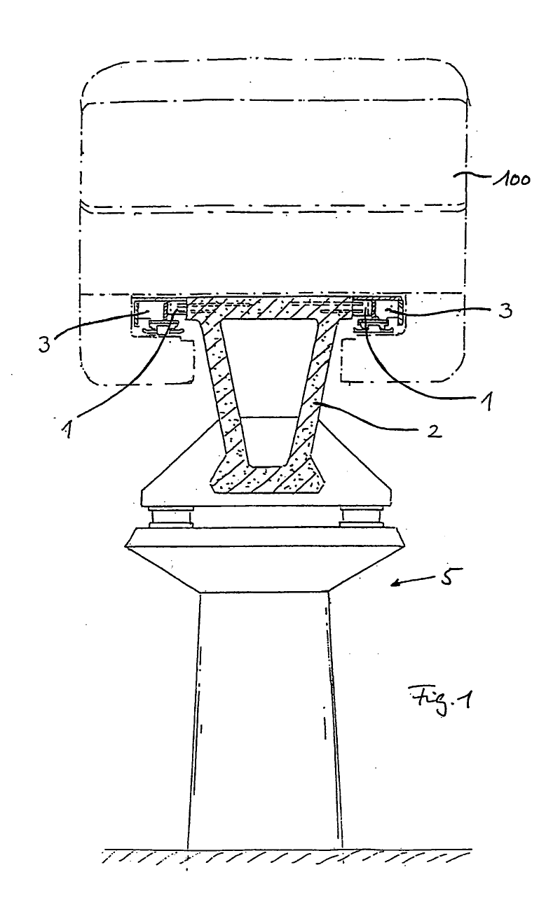

FIG. 1 shows a roadway with a magnetic suspended railway in cross section.

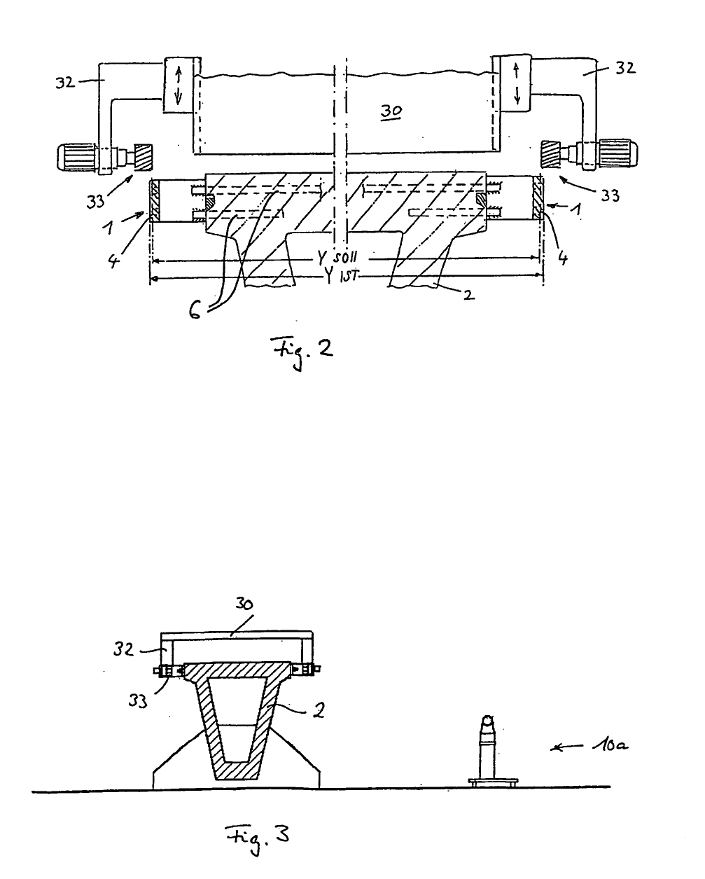

FIG. 2 shows a front view of a machining device and of a connecting console to be machined and located on a carrier.

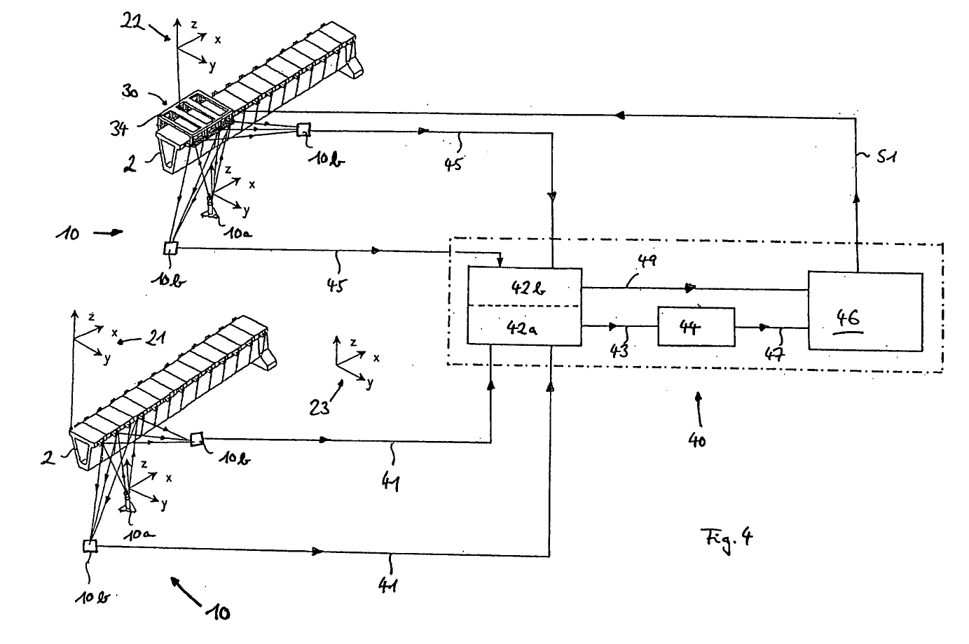

FIG. 3 shows a front view of a carrier with a machining device set on it and shows a determining device.

FIG. 4 shows a schematic view of the method course.

The invention is described by way of example using the machining of construction modules of a hybrid carrier system for rail-bound vehicles. Such a carrier system is described in detail in EP 0 987 370 A1, the disclosed content of which is included herewith.

FIG. 1 shows a roadway for a magnetic suspended railway 100 in section. Carriers 2 consisting preferably of pre-stressed concrete are fastened to the construction site on supports 5. Several carriers 2 are set up in series in the direction of travel of the roadway. Connecting consoles 1 consisting preferably of steel are arranged laterally on each carrier 2 at the same interval. Each connecting console 1 is welded or screwed to an anchoring rod 6 (see FIG. 2) for fastening, which is let into the pre-stressed concrete of carrier 2. Each console 1 comprises a head plate 4 to which operational plane carriers 3 are attached. To this end each head plate 4 must be exactly determined and machined if needed.

FIG. 2 shows a section of a carrier 2 with connecting consoles 1 fastened to both its sides with the aid of anchoring rods 6. The actual distance of the two head surfaces 4 of the two connecting consoles is designated by Yᵢₛₜ and the required distance by Y_{SOLL}. In order to bring the distance of head surfaces 4 to the required value, machining device 30 is provided on carrier 2 that has height-adjustable (see arrows) arms 32 on both sides with milling heads 33 arranged on their ends. The particular head surface 4 is machined by moving the particular arm 32 up and down.

FIG. 3 shows a schematic front view of an entire carrier 2 with machining device 30 set on it. Laser 10a of a determining device 10 is placed at the side of carrier 2 which device determines in independent steps on the one hand carrier 2 and especially connecting consoles 1 and on the other hand machining device 30.

The method of the invention for this determination and optional machining is described in the following using the schematic view of FIG. 4. At first, a laser 10a is placed as part of determining device 10 in front of stationary carrier 2, on account of its size and weight, and determines carrier 2 or a carrier section. The laser beams shown in the form of straight lines 11 with arrowheads are reflected on carrier 2 and pass to one or more measuring elements 10b, e.g., measuring sensors, whose measuring signals are conducted further via lines 41 to calculating unit 42a of computer 40 in order to determine the shape and the position of carrier 2 and of connecting consoles 1, that is, of the workpiece from the running time and the direction of the returning laser beams.

It is particularly known that spheres and partial spheres that have a small diameter in comparison to the surface to be determined can be arranged at defined positions of the surface in order to obtain statements about the course of the surface from the beams reflected from the sphere surface. These spheres or partial spheres are not shown in FIG. 4.

In such a determining step, e.g., an accuracy of approximately 0.5 mm is achieved in the three spatial directions. In order to assure the required tolerances in any subsequent machining a second partial determining step can be performed. For this, a partial range of the previously measured carrier section is determined, preferably with the same determining device 10. This step is not shown in FIG. 4. For example, an accuracy of determination of approximately 0.03 mm can be achieved with the above. The actual space curve of carrier 2 is calculated in a first coordinate system 21 from the measured signals of the two partial determining steps by calculating unit 42a, which curve is then transmitted further via line 43 to comparison module 44 in order that it can compare the actual geometry with the stored theoretical space curve of carrier 2. This data then serves for the subsequent machining of head plates 4.

Machining device 30 shown in FIGS. 2, 3 is provided for this machining and is likewise determined by determining device 10. The determination data serve in particular to determine the position of machining device in a second coordinate system 22 that according to the invention is independent of the first coordinate system 21.

To this end machining device 30 is set without a very precise adjustment on carrier 2 since machining device 30 at first does not require any exact guidance or positioning on account of the functional separation of coordinate systems 21, 22. Machining device 30 is subsequently determined by determining device 10. The same measuring elements 10b are preferably used to this end as for the determining of carrier 2, that then pass the measured signals on via lines 45 to calculating unit 42b of computer 40.

Machining device 30 shown in FIGS. 2 to 4 is set on carrier 2. In this embodiment machining device 30 has a frame 34 (FIG. 4) extending over the distance of several head plates 4. Several machining units with milling heads 33 shown in FIGS. 2, 3 are arranged opposite head plates 4 and staggered on frame 34 in the longitudinal direction of carrier 2, that assume the machining of a head plate 4. As a result, the machining of head plates 4 of carrier 2 can take place in sections; during which the machining advantageously takes place simultaneously on both sides of the carrier.

After the machining of a section with several head plates 4, frame 34 is shifted into the next section to be machined, machining unit 30 or the machining units are determined and the machining is subsequently carried out.

In an alternative embodiment of the invention (not shown) machining device 30 or the machining devices can also be arranged, e.g., on a gantry crane or the like that can move along carrier 2 and makes no contact with carrier 2.

It is advantageous if machining device 30 is repeatedly determined during the machining of head plates 4. This can take place in a step-by-step manner or also continuously. This procedure permits a constant checking of the progress of the machining and of the adjusting of machining device 30.

In order to be able to give machining device 30 the necessary machining commands the determination data of determining device 10 and the determination data of machining device 30 must be brought into a relationship with each other. This means that the first and the second coordinate systems 21, 22 must be correlated. To this end the particular signals and data records are fed via lines 47, 49 into calculating unit 46 of computer 40 where the spatial relationships between carrier 2 and machining device 30 are created and machining commands are derived from them that are passed on via line 51 to machining device 30. In such a machining step in particular the corresponding surfaces of head plates 4 are milled for an accurately fitting mounting of operational plane carriers 3.

In order to produce the correlation of first and of second coordinate systems 21, 22 a transformation of coordinates from the one coordinate system into the other one can be carried out. In order to make this possible it must be assured that the position of laser 10a in space is known, that is, its position must be calibrated. The opportunity presents itself here that beams emitted from laser 10a are received directly by receivers 10b and are evaluated by calculating units 42a, 42b (these direct beams are not sketched in FIG. 4 for the sake of clarity). The position of determining device 10 in space can then be determined and the desired transformation of coordinates carried out.

As an alternative, the first and the second coordinate system 21, 22 are brought into a relationship in a third, global (that is, spatially fixed) coordinate system 23 and the commands for machining workpiece 1, 2 are generated in this latter coordinate system. It is also necessary for this to determine and calibrate determining device 10 in space, advantageously in the same manner as described above.

Determining device 10 is advantageously designed to be mobile, which is particularly advantageous when determining in several partial steps. In order to achieve, e.g., the finer resolution in the above-mentioned second partial determining step for a section of carrier 2, determining device 10 is placed closer to carrier 2. Determining device 10 can be positioned elsewhere even during the machining of head plates 4 in order to take into account the movement of machining device 30.

Determining device 10 can also be coupled or fastened with advantage to machining device 30.

Instead of the above-described machining with a machining device a measuring by an appropriately designed measuring device (not shown) is also possible using the method of the invention. For example, the temperature, color, electrical magnitudes, surface structures, etc. can be measured.

The invention can be used during the determining and during the measuring and/or machining of a stationary workpiece or of a moving workpiece. In the latter variant a multiple determining of the workpiece is advantageous.

1. A method for measuring and/or machining a workpiece (1, 2), especially modules in building construction by means of a measuring and/or machining device (30), in which the workpiece (1, 2) is determined in a first coordinate system (21) with the aid of at least one determining device (10) and that the measuring and/or machining device (30), that can move relative to the workpiece (1, 2) is determined in a second coordinate system (22) independently of the position and the shape of the workpiece (1, 2), and that the coordinates of the workpiece (1, 2) on the one hand and the coordinates of the measuring and/or machining device (30) on the other hand are brought into a relationship with each other by a computer (40) in order to control the measuring and/or machining device (30) for measuring and/or machining the workpiece (1, 2).

2. The method according to claim 1, characterized in that the workpiece (1, 2) is arranged to be stationary.

3. The method according to claim 1 or 2, characterized in that the first and the second coordinate systems (21, 22) are brought into a relationship with one another in a third coordinate system (23).

4. The method according to one of the previous claims, characterized in that the workpiece (1, 2) is determined in at least two partial determination steps, that a relatively large section of the workpiece (1, 2) is determined with a rather low resolution in one partial determination step and in another partial determination step with a finer resolution a partial section of the larger section is determined, and that the data determined in the partial determination steps is adjusted by a computer.

5. The method according to one of the previous claims, characterized in that a deviation of the actual state of the workpiece (1, 2) from its theoretical state is calculated using the determined shape of the workpiece (1, 2) in order to determine the necessary machining steps.

6. The method according to one of the previous claims, characterized in that the measuring and/or machining device (30) is determined repeatedly and preferably step-by-step or continuously in the second coordinate system (22) during the measuring and/or machining of the workpiece (1, 2).

7. The method according to one of the previous claims, characterized in that measuring beams, especially laser beams, are transmitted from at least one transmitting module (10a) of the determining device (10) to the workpiece (1, 2) and/or to the measuring and/or machining device (30), and that measuring beams reflected on the workpiece (1, 2) or on the measuring and/or machining device (30) are received by at least one sensor (10b) arranged in space and designed as a receiving module of the determining device (10).

8. The method according to claim 7, characterized in that the determining of the workpiece (1, 2) and/or of the measuring and/or machining device (30) is carried out by laser interferometry.

9. The method according to claim 7 or 8, characterized in that reflection elements are placed in the immediate vicinity of the surfaces to be determined and that beams reflected on the reflection elements are received by at least one receiving module (10b) of the determining device (10).

10. The method according to claim 9, characterized in that the reflection elements comprise at least one spherical section on which measuring beams are reflected toward the receiving module (10b).

11. The method according to one of the previous claims, characterized in that at least one transmitting module (10a) of the determining device (10) moves in a defined manner with the measuring and/or machining device (30) in the second coordinate system (22) during the determining of the measuring and/or machining device (30).

12. The method according to one of claims 1 to 10, characterized in that the determining device (10) is arranged in a stationary manner during the determining of the measuring and/or machining device (30).

13. The method according to one of the previous claims, characterized in that the measuring and/or machining device (30) comprises at least one, preferably several measuring and/or machining devices (33) that can preferably be controlled individually.

14. The method according to claim 13, characterized in that the measuring and/or machining device (30) is moved close to the workpiece (1, 2) and the individual measuring and/or machining devices (33) are subsequently moved into their work positions in order to measure and/or machine the workpiece (1, 2).

15. The method according to one of the previous claims, characterized in that the measuring and/or machining device (30) is set onto the workpiece (1, 2).

16. The method according to one of claims 1 to 14, characterized in that the measuring and/or machining device (30) is placed next to the workpiece without making contact with it.
